(19) United States
(12) Patent Application Publication
(10) Pub. No.: US 2018/0242781 A1
(43) Pub. Date: Aug. 30, 2018

(54) Electric Baking Tray Compatible with Alternating Current (AC) and Direct Current (DC)

(71) Applicant: Qiming Du, Guangdong Province (CN)

(72) Inventor: Qiming Du, Guangdong Province (CN)

(21) Appl. No.: 15/442,059

(22) Filed: Feb. 24, 2017

(51) Int. Cl. A47J 37/01; H05B 3/68

(52) U.S. Cl. CPC A47J 37/015; H05B 2203/028; H05B 3/68

(57) ABSTRACT

The present application discloses an electric baking tray compatible with alternating current (AC) and direct current (DC), which comprises a front panel, a heating film, a heat insulating device, a bottom case, a control panel, an isolation plate and a DC power supply device; wherein the bottom case is internally provided with the control panel; the DC power supply device is detachably and fixedly connected with the bottom case; the DC power supply device comprises a rechargeable battery, an inverter and a transfer switch which are electrically connected sequentially; and the transfer switch is electrically connected with the power socket and the control panel respectively. In the technical solution, the baking tray is heated more evenly and compatible with AC and DC modes.

### FIELD OF THE INVENTION

The present application relates to the technical field of baking trays and particularly to an electric baking tray.

### BACKGROUND OF THE INVENTION

An electric baking tray is a modern popular barbecue device for a smoke-free non-stick pan and can be used for baking mutton shashlik, roasting meat, frying rice, baking flour shells, frying beef steak, frying dumplings, etc.

Chinese Patent Application Publication No. CN106037507A published on Oct. 26, 2016 discloses a multifunctional electric baking tray, which comprises a base 1, a tray body 2, a heating element 3 equipped with a connecting terminal 31, and a temperature controller 5 detachably connected with the base; wherein the tray body and the base are separately arranged, and the heating element 3 is fixedly connected on a lower surface of the tray body 2; and the temperature controller 5 is provided with a power port 51 which can be electrically connected with the connecting terminal 31, a telescopic limiting member is arranged at a position of the temperature controller 5 which corresponds to the power port 51, and the base is provided with a mating member which cooperates with the limiting member to facilitate stretching and retraction of the limiting member.

Upon analysis, the applicant has found that the above technical solution and the electric baking trays of other applicants in the prior art have the following defects: (1) these electric baking trays need to be supplied with AC power and therefore can be used only at home; and (2) heating elements for the electric baking trays are generally heating tubes, but tubular heating elements have the problem of heating non-uniformity.

How to solve the above technical defects of an existing electric baking tray is a subject to be urgently studied and improved by the applicant of the present application and relevant manufacturers engaged in this industry.

### SUMMARY OF THE INVENTION

To overcome the problems existing in the prior art, the present application provides an electric baking tray compatible with alternating current (AC) and direct current (DC) which can be either used at home or used outdoors by a DC power supply.

To achieve the above objective, the present application provides the following technical solution: an electric baking tray compatible with alternating current (AC) and direct current (DC) comprises a front panel, a heating body, a heat insulating device, a bottom case, a control panel, an isolation plate and a DC power supply device; wherein the front panel is fixedly connected with the heat insulating device; the heating body is arranged between the front panel and the heat insulating device; the heating body is a heating film; the isolation plate is fixedly connected with the isolation device and the bottom case respectively; the bottom case is provided with a power socket; the bottom case is internally provided with the control panel; the control panel is electrically connected with the power socket and the heating body respectively; the DC power supply device is detachably and fixedly connected with the bottom case; the DC power supply device comprises a rechargeable battery, an inverter and a transfer switch which are electrically connected sequentially; and the transfer switch is electrically connected with the power socket and the control panel respectively.

After the technical solution of the present application is adopted, firstly, AC is directly used; and secondly, the baking tray is directly supplied with power by the DC power supply device such that the electric baking tray may be used either at home or outdoors. A heating film as the heating body avoids the problem of heating non-uniformity of an existing heating tube such that the whole front panel is heated more evenly and sufficiently and therefore food is baked more sufficiently. The DC power supply device is detachably fixed to the bottom case such that (1) the electric baking tray claimed in the present application is characterized by convenience in maintenance; and (2) modular design can be applied to products previously produced by the applicant. A further improvement is that the bottom case is provided with a chamber in which the rechargeable battery and the inverter are mounted; the power socket comprises an AC socket and a DC socket; the AC socket and the DC socket are respectively provided with an anti-misplugging structure; and the transfer switch is fixed nearby the power socket. When the technical solution is adopted, switching between AC and DC modes can be directly performed by the transfer switch with great convenience. When AC is used, the transfer switch is first switched to an AC position and then a power line is plugged and connected to AC to work. If power is supplied by the rechargeable battery, the transfer switch is first switched to a DC power supply mode, the DC socket is electrically connected with the inverter via a power line, and then the rechargeable battery directly supplies power to the electric baking tray. The AC socket and the DC socket are respectively provided with an anti-misplugging structure; and the obviously different structures eliminate the concern for plugging into a wrong position.

A further improvement is that the front panel is a glass-ceramic panel. The glass-ceramic panel has the advantages of ultra-high thermal conductivity, strong uniform thermal conductivity and convenience in cleaning.

A further improvement is that an oil discharge hole is arranged at one end of the isolation plate; an oil receiving box is arranged below the isolation plate; and the oil receiving box is detachably and fixedly connected with a base. A detachable design of the oil discharge hole and the oil receiving box provides the advantages of: (1) convenience in cleaning; and (2) less or no oil smoke produced during use.

A further improvement is that the heat insulating device comprises a heat insulating plate and a heat insulating bottom plate which are made of a heat insulating material; the heat insulating plate is fixedly connected with the heat insulating bottom plate; and the heat insulating bottom plate is fixedly connected with the isolation plate. The design of the heat insulating plate and the heat insulating bottom plate provides the advantages of: (1) convenience in machining; (2) good thermal insulation effects; and (3) reduction in maintenance cost of a user by replacing separate components after long-time use.

### BRIEF DESCRIPTION OF THE DRAWINGS

FIG. 1 is a schematic exploded view of an electric baking tray compatible with alternating current (AC) and direct current (DC).

In the FIGURE: 1. front panel; 2. heating body; 3. heat insulating device; 4. bottom case; 5. control panel; 6. isolation plate; 7. rechargeable battery; 8. inverter; 9. transfer switch; 10. chamber; 11. AC socket; 12. DC socket; 13. oil receiving box; 31. heat insulating plate; 32. heat insulating bottom plate; 61. oil discharge hole.

### DETAILED DESCRIPTION OF THE INVENTION

A preferred embodiment of the present application will be further described below with reference to the accompany drawing.

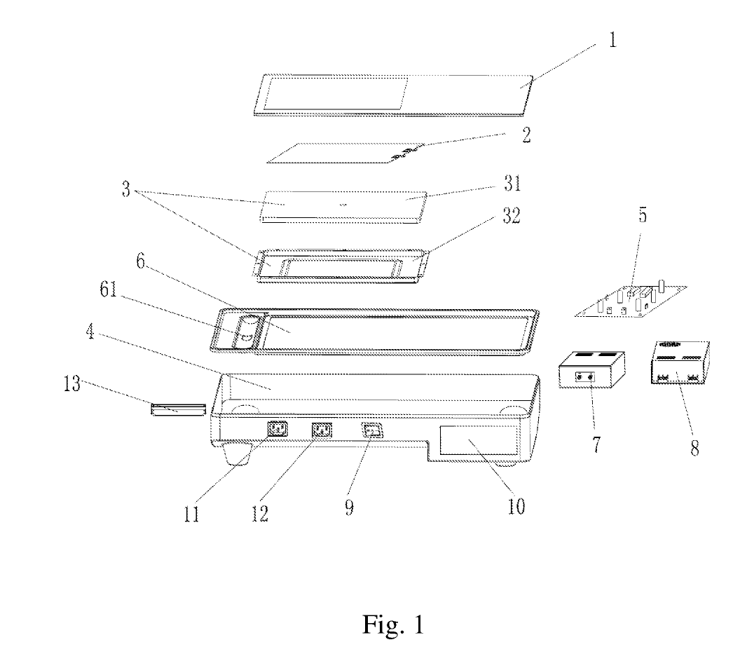

As shown in FIG. 1, an electric baking tray compatible with alternating current (AC) and direct current (DC) comprises a front panel 1, a heating body 2, a heat insulating device 3, a bottom case 4, a control panel 5, an isolation plate 6 and a DC power supply device. The front panel is a glass-ceramic panel; and the heating body is a heating film.

The front panel is fixedly connected with the heat insulating device; the heating body is arranged between the front panel and the heat insulating device; the isolation plate is fixedly connected with the isolation device and the bottom case respectively; the heat insulating device comprises a heat insulating plate 31 and a heat insulating bottom plate 32 which are made of a heat insulating material; the heat insulating plate is fixedly connected with the heat insulating bottom plate; and the heat insulating bottom plate is fixedly connected with the isolation plate. An oil discharge hole 61 is arranged at one end of the isolation plate; an oil receiving box 13 is arranged below the isolation plate; and the oil receiving box is detachably and fixedly connected with a base.

The bottom case is provided with a power socket and a chamber 10 in which the rechargeable battery and the inverter are mounted; the power socket comprises an AC socket 11 and a DC socket 12; the AC socket and the DC socket are respectively provided with an anti-misplugging structure; and the anti-misplugging structure preferred in the present application is as follows: the two sockets have different structural shapes to avoid misplugging by a user during use. The transfer switch is fixed nearby the power socket.

The bottom case is internally provided with the control panel; the control panel is electrically connected with the power socket and the heating body respectively; the DC power supply device is detachably and fixedly connected with the bottom case; the DC power supply device comprises a rechargeable battery 7, an inverter 8 and a transfer switch 9 which are electrically connected sequentially; and the transfer switch is electrically connected with the power socket and the control panel respectively.

The present application is not limited to the above most preferred embodiment, and various forms of other products can be obtained by any person under the inspiration of the present application. However, regardless of any change to its shape or structure, any technical solution which is the same as or similar to the present application shall fall into the protection scope of the present application.

What is claimed is:

1. An electric baking tray compatible with alternating current (AC) and direct current (DC), comprising a front panel (1), a heating body (2), a heat insulating device (3), a bottom case (4), a control panel (5), an isolation plate (6) and a DC power supply device; the front panel being fixedly connected with the heat insulating device; the heating body being arranged between the front panel and the heat insulating device; the heating body being a heating film; the isolation plate being fixedly connected with the isolation device and the bottom case respectively; the bottom case being provided with a power socket; the bottom case being internally provided with the control panel; the control panel being electrically connected with the power socket and the heating body respectively; the DC power supply device being detachably and fixedly connected with the bottom case; the DC power supply device comprising a rechargeable battery (7), an inverter (8) and a transfer switch (9) which are electrically connected sequentially; and the transfer switch being electrically connected with the power socket and the control panel respectively.

2. The electric baking tray compatible with AC and DC according to claim 1, wherein the bottom case is provided with a chamber (10) in which the rechargeable battery and the inverter are mounted; the power socket comprises an AC socket (11) and a DC socket (12); the AC socket and the DC socket are respectively provided with an anti-misplugging structure; and the transfer switch is fixed nearby the power socket.

3. The electric baking tray compatible with AC and DC according to claim 1, wherein the front panel is a glass-ceramic panel.

4. The electric baking tray compatible with AC and DC according to claim 1, wherein an oil discharge hole (61) is arranged at one end of the isolation plate; an oil receiving box (13) is arranged below the isolation plate; and the oil receiving box is detachably and fixedly connected with a base.

5. The electric baking tray compatible with AC and DC according to claim 1, wherein the heat insulating device comprises a heat insulating plate (31) and a heat insulating bottom plate (32) which are made of a heat insulating material; the heat insulating plate is fixedly connected with the heat insulating bottom plate; and the heat insulating bottom plate is fixedly connected with the isolation plate.
